(19) United States
(12) Patent Application Publication
(10) Pub. No.: US 2014/0291567 A1
(43) Pub. Date: Oct. 2, 2014

(54) INDUSTRIAL COMPONENT COMPRISING A SILICON EUTECTIC ALLOY AND METHOD OF MAKING THE COMPONENT

(71) Applicant: Dow Corning Corporation, Midland, MI (US)

(72) Inventors: Robert T. Larsen, Midland, MI (US); Edward K. Nyutu, Saginaw, MI (US); Vasgen Shamamian, Midland, MI (US); Joseph Sootsman, Freeland, MI (US); James Young, Midland, MI (US)

(21) Appl. No.: 14/305,205

(22) Filed: Jun. 16, 2014

Related U.S. Application Data
(63) Continuation of application No. PCT/US2012/071242, filed on Dec. 21, 2012.
(60) Provisional application No. 61/579,932, filed on Dec. 23, 2011.
(60) Provisional application No. 61/727,261, filed on Nov. 16, 2012.

(51) Int. Cl. F16K 3/02

(52) U.S. Cl. CPC F16K 3/0227
USPC 251/359

(57) ABSTRACT

An industrial component comprising a Si eutectic alloy comprises a body having a wear surface, where both the body and the wear surface comprise a eutectic alloy including silicon, one or more metallic elements M, and a eutectic aggregation of a first phase comprising the silicon and a second phase of formula MSi₂, where the second phase is a disilicide phase. The wear surface comprises a resistance to erosive wear sufficient to limit transfer of, when an abrasive product is passing thereacross, at least one of the one or more more metallic elements therefrom to the abrasive product, such that the abrasive product comprises an increase in contamination level of 200 parts per billion (ppb) or less of the at least one of the one or more metallic elements M after the passage. The body may also comprise a fracture toughness of at least about 3.2 MPa·m^{1/2}.

### CROSS-REFERENCE TO RELATED APPLICATIONS

This patent application is a continuation of International Patent Application No. PCT/US2012/071242, filed Dec. 21, 2012, and claims priority to U.S. Provisional Patent Application No. 61/579,932, filed Dec. 23, 2011, and claims priority to U.S. Provisional Patent Application No. 61/727,261, filed Nov. 16, 2012. Each of the above-identified patent applications is incorporated herein by reference in its entirety.

### TECHNICAL FIELD

The present disclosure is directed generally to industrial components comprising silicon (Si) eutectic alloys and more particularly to wear-resistant components for valves.

### BACKGROUND

A need exists for corrosion- and wear-resistant ceramic components with good fracture toughness in numerous industries. While common technical ceramics such as silicon carbide, silicon nitride and others may be capable of filling this need at small scales for some applications, the powder pressing techniques by which they are made limit the size of parts available.

It has recently been recognized that silicon (Si) eutectic alloys, which may have properties competitive with technical ceramics, can be fabricated by melting and casting processes (see, e.g., WO 2011/022058). A challenge has been fabricating such alloys with sufficient control over the melting and casting process to achieve an oriented eutectic microstructure exhibiting a desirable set of mechanical properties.

### BRIEF SUMMARY

Melting and casting methods or processes may be employed to fabricate a wear-resistant component of a complex shape and large size based on a Si eutectic alloy. By controlling the fabrication process to produce a desired eutectic microstructure, the wear-resistant component may exhibit mechanical properties such as wear resistance and fracture toughness that are competitive with the mechanical properties of widely used technical ceramics. The Si eutectic alloy may further exhibit excellent corrosion resistance. Described herein are an industrial component comprising a Si eutectic alloy, a wear-resistant component for a valve, a wear-resistant valve, and a method of making a wear-resistant component.

The industrial component may comprise a body having a wear surface, where both the body and the wear surface comprise a Si eutectic alloy including silicon, one or more metallic elements M, and a eutectic aggregation of a first phase comprising the silicon and a second phase of formula MSi₂, where the second phase is a disilicide phase. The wear surface comprises a resistance to erosive wear sufficient to limit transfer of, when an abrasive product is passing thereacross, at least one of the one or more metallic elements M therefrom to the abrasive product, such that the abrasive product comprises an increase in contamination level of 200 parts per billion (ppb) or less of the at least one of the one or more metallic elements M after the passage. The body may also or alternatively comprise a fracture toughness of at least about 3.2 megaPascals·meters^{1/2}(MPa·m^{1/2}). The body may also or alternatively comprise a corrosion rate of less than 1 mil per year (mpy) in a heated aqueous solution comprising an acid.

The industrial component may comprise a body comprising a eutectic alloy including silicon, one or more metallic elements M, and a eutectic aggregation of a first phase comprising the silicon and a second phase of formula MSi₂, the second phase being a disilicide phase, wherein the body comprises a fracture toughness of at least about 3.2 megaPascals·meter^{1/2} (MPa·m^{1/2}), and wherein the body comprises a corrosion rate of less than 1 mil per year (mpy) in a heated aqueous solution comprising an acid.

The wear-resistant component for a valve includes a body comprising an obstructing surface and a sealing surface at a periphery of the obstructing surface, at least one of the obstructing surface and the sealing surface being a wear surface comprising a Si eutectic alloy including silicon, one or more metallic elements M, and a eutectic aggregation of a first phase comprising the silicon and a second phase of formula MSi₂; the second phase is a disilicide phase. The wear surface comprises a resistance to erosive wear sufficient to limit transfer of, when an abrasive product is passing thereacross, at least one of the one or more metallic elements M therefrom to the abrasive product, such that the abrasive product comprises an increase in contamination level of 200 parts per billion (ppb) or less of the at least one of the one or more metallic elements M after the passage.

The wear-resistant valve comprises a valve body including an inlet and an outlet and defining a passageway therebetween for passage of a material from the inlet to the outlet; a valve seat coupled to or integrally formed with the valve body between the inlet and the outlet, where the valve seat defines an opening in the passageway for passage of the material therethrough; and a sealing component comprising a body having an obstructing surface and a sealing surface at a periphery of the obstructing surface, where the sealing component is disposed within the passageway and configured for motion between a closed position and an open position. When the sealing component is in the closed position, the sealing surface is engaged with the valve seat and the obstructing surface completely obstructs the opening, and, when the sealing component is in the open position, the sealing surface is disengaged from the valve seat such that the opening allows the passage of the material therethrough. At least one of the sealing component, the valve body and the valve seat comprises a wear surface comprising a Si eutectic alloy including silicon, one or more metallic elements M, and a eutectic aggregation of a first phase comprising the silicon and a second phase of formula MSi₂. The second phase is a disilicide phase.

The method of making a wear-resistant component comprises: melting together silicon and one or more metallic elements M to form a eutectic alloy melt comprising silicon and the one or more metallic elements M; directionally removing heat from the eutectic alloy melt to directionally solidify the eutectic alloy melt, and forming a wear-resistant component having a wear surface comprising a eutectic alloy comprising the silicon, the one or more metallic elements M, and a eutectic aggregation of a first phase comprising the silicon and a second phase of formula MSi₂, the second phase being a disilicide phase. The wear surface has a resistance to erosive wear sufficient to limit transfer of, when an abrasive product is passing thereacross, at least one of the one or more metallic elements M therefrom to the abrasive product, such that the abrasive product comprises an increase in contamination level of 200 parts per billion (ppb) or less of the at least one of the one or more metallic elements M after the passage.

The silicon eutectic alloy composition may be advantageously used in any of a number of industries, such as the oil and gas, semiconductor, automotive, machine parts and solar industries, in which a component exhibiting good wear resistance and/or other favorable mechanical properties is desired.

### BRIEF DESCRIPTION OF THE DRAWINGS

FIG. 1 is a perspective cross-sectional view of an exemplary dome valve including a sealing component, valve seat and valve body;

FIGS. 2A and 2B are perspective cross-sectional views of the dome valve of FIG. 1 connected to an exemplary fluidized bed reactor, where the dome valve is in a closed (FIG. 2A) and open (FIG. 2B) position;

FIG. 3 shows the phase diagram for the Si—Cr alloy system;

FIG. 4 is an optical micrograph of a portion of a surface of an exemplary Si—CrSi₂ alloy sample;

FIG. 5 shows a cast sealing component for a dome valve, where the sealing component comprises a Si—CrSi₂ alloy;

FIGS. 6A-6B are optical micrographs of the microstructure of a cast and polished sealing component for a dome valve, where FIG. 6A shows rod-like features growing along the direction of heat flow approximately 1 mm from the surface of the casting, and FIG. 6B shows isotropic grains from the central region of the casting;

FIG. 7 shows the coefficient of friction between a Si abrasive ball and a fixed plate of a Si—CrSi₂ sample prepared by rotational casting during the course of a standard measurement cycle, where the discontinuities during the runs are a result of increased force to maintain 25N during testing;

FIG. 8 shows the fracture toughness of Si—CrSi₂ alloys prepared by rotational casting as a function of thermal treatment as well as testing in brine solution for extended periods (4-6 months) of time;

FIGS. 9A-9D show pictures of Si—CrSi₂ eutectic alloy test coupons before and after immersion in a boiling aqueous solution containing 20 wt. % HCl for up to 144 hours;

FIG. 10 shows normalized general corrosion rates of various engineering alloys and Si—CrSi₂ eutectic alloys, and the inset provides corrosion rates in mils/yr (mpy) and mg/cm²yr, where the test values were determined from an average of 2-3 24 hour exposures, and nil is less than or equal to 1 mpy;

FIGS. 11A-11G show additional pictures of alloy test coupons before and after immersion in a boiling aqueous solution containing 20 wt. % HCl; and

FIGS. 12A-12L are scanning electron micrographs of test coupons before (A, C, E, G, I, K) and after (B, D, F, H, J, L) immersion in a boiling aqueous solution containing 20 wt. % HCl for 24 hours, where the “before” surfaces are polished surfaces and the alloys shown are a cobalt superalloy (Elgiloy), Alloy 20, Type 316L, Alloy X, Alloy C-276, and a Si—CrSi₂ eutectic alloy, respectively.

### DETAILED DESCRIPTION

It is noted that the terms “comprising,” “including” and “having” are used interchangeably throughout the specification and claims as open-ended transitional terms that cover the expressly recited subject matter alone or in combination with unrecited subject matter.

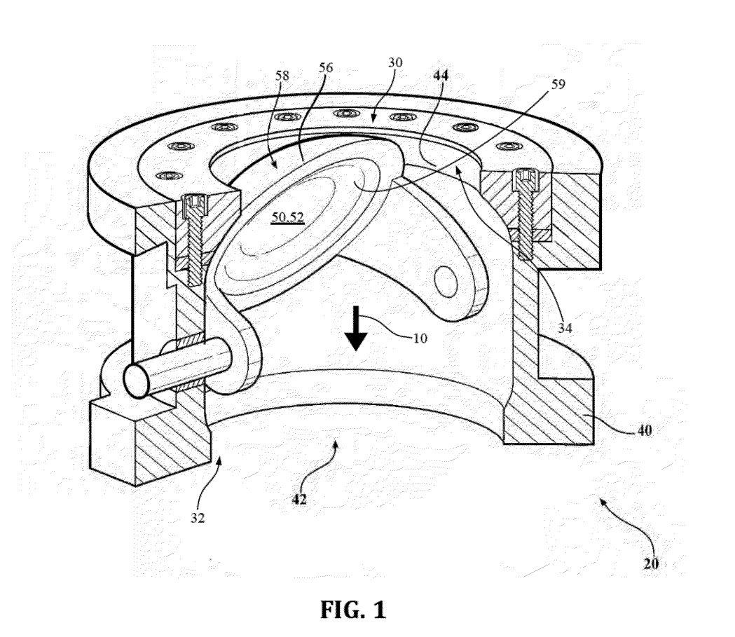

The present disclosure relates to wear-resistant Si eutectic alloys that also may exhibit exceptional corrosion resistance. The melting and casting methods described herein may be employed to fabricate a wear- and corrosion-resistant industrial component based on a Si eutectic alloy, such as one or more components of a valve, as shown in FIG. 1. The industrial component may be of a complex shape and large size. Due to the exceptional erosive wear behavior of the component, valve applications may be particularly advantageous, although usage of the component is not of course limited to valves.

According to one embodiment, the industrial component has a body comprising a wear surface, the body and the wear surface comprising a eutectic alloy including silicon, one or more metallic elements M, and a eutectic aggregation of a first phase comprising the silicon and a second phase of formula MSi₂, where the second phase is a disilicide phase. An exemplary industrial component, more specifically a wear-resistant component for a valve 20, is shown in FIG. 1, as described in further detail below. The wear surface comprises a resistance to erosive wear that is sufficient to limit transfer of, when an abrasive product is passing thereacross, at least one of the one or more metallic elements M therefrom to the abrasive product, where the abrasive product comprises an increase in contamination level of 200 parts per billion (ppb) or less of the at least one of the one or more metallic elements M after the passage. The body may also or alternatively comprise a corrosion rate of less than 1 mil per year (mpy) in a heated aqueous solution comprising an acid.

For valve applications, the wear-resistant component (e.g., the sealing component 50 shown in FIG. 1) may have a body 52 having an obstructing surface 58 for blocking passage of a material and a sealing surface 56 at a periphery of the obstructing surface 58, where at least one of the obstructing surface 58 and the sealing surface 56 is a wear surface comprising a eutectic alloy including silicon, one or more metallic elements M, and a eutectic aggregation of a first phase comprising silicon and a second phase of formula MSi₂. The second phase is a disilicide phase. The wear surface comprises a resistance to erosive wear sufficient to limit transfer of, when an abrasive product is passing thereacross, at least one of the one or more metallic elements M therefrom to the abrasive product, the abrasive product comprising an increase in contamination level of 200 parts per billion (ppb) or less of the at least one of the one or more metallic elements M after the passage.

The first phase may be an elemental silicon phase or an intermetallic compound phase selected from MSi and M₅Si₃, and the one or more elements M may selected from the group consisting of Cr, V, Nb Ta, Mo, W, Co, Ni, and Ti. The eutectic aggregation may include high aspect ratio structures of one of the first and second phases, and wherein at least a portion of the high aspect ratio structures are oriented substantially perpendicular to the wear surface of the body.

The wear surface may be a curved surface and each of the oriented high aspect ratio structures may be oriented substantially perpendicular to a respective nearest position on the curved wear surface. For example, referring again to FIG. 1, the body 52 may comprise a dome having a top portion and an edge, the top portion of the dome comprising the obstructing surface 58 and the edge of the dome comprising the sealing surface 56, the sealing component 50 being a dome valve component.

The body may comprise a corrosion rate of less than 1 mil per year (mpy) in a heated aqueous solution comprising an acid at a concentration of at least about 10 wt. %. The heated aqueous solution may be at or above a boiling point thereof, and wherein the acid may be selected from the group consisting of sulfuric acid, phosphoric acid, formic acid, nitric acid, and hydrochloric acid. The body may have a fracture toughness of at least about 2.5 MPa·m^{1/2} measured in a direction perpendicular to the wear surface of the body. The body may comprise a fracture toughness of at least about 6 MPa·m^{1/2} measured in a direction along the wear surface of the body.

FIG. 1 shows an exemplary valve 20 including a valve body 40 comprising an inlet 30 and an outlet 32 and defining a passageway 42 therebetween for passage of a material in the direction of arrow 10 from the inlet 30 to the outlet 32. Coupled to or integrally formed with the valve body 40 between the inlet 30 and the outlet 32 is a valve seat 44 defining an opening 34 in the passageway 42 for passage of the material therethrough. A sealing component 50 comprising a body 52 having an obstructing surface 58 and a sealing surface 56 at a periphery of the obstructing surface 58 is disposed within the passageway 42. The sealing component 50 is configured for motion between a closed position and an open position. When the sealing component 50 is in the closed position, the sealing surface 56 is engaged with the valve seat 44 and the obstructing surface 58 completely obstructs the opening 34. When the sealing component 50 is in the open position, the sealing surface 56 is disengaged from the valve seat 44 such that the opening 34 allows the passage of the material therethrough.

At least one of the sealing component 50, the valve body 40 and the valve seat 44 includes a wear surface comprising a Si eutectic alloy. The Si eutectic alloy includes at least 50 atomic percent silicon, one or more metallic elements M, and a eutectic aggregation of a first phase comprising silicon and a second phase of formula MSi₂, the second phase being a disilicide phase.

The first phase, which can be referred to as a “silicon-containing phase,” may be an elemental silicon phase or an intermetallic compound phase. When the first phase is an elemental silicon phase, the first phase comprises silicon in the form of crystalline silicon and/or amorphous silicon. When the first phase is an intermetallic compound phase, the first phase includes silicon and the element(s) M and has the formula Mₓ Si_{y}, where x and y are integers. Generally, the intermetallic compound phase is different from the disilicide phase, and thus x is not 1 and y is not 2.

The wear surface comprising the Si eutectic alloy may be any surface that comes into contact with the material passing through the valve. For example, there may be a plurality of wear surfaces, such as both of the sealing surface 56 and the obstructing surface 58 of the sealing component. The underside 59 of the body 52 may also be a wear surface. The wear surface(s) comprising the Si eutectic alloy have a resistance to erosive wear, when an abrasive product is passing thereacross, that is sufficient to limit transfer of at least one of (and up to all of) the metallic element(s) M therefrom to the abrasive material, such that the abrasive material comprises an increase in contamination level of 200 parts per billion (ppb) or less of the at least one of the metallic element(s) M after the passage. The increase in contamination level may also be less than 100 ppb, less than 10 ppb, or less than 1 ppb. As used herein, “abrasive material” refers to a material having a Mohs hardness greater than or equal to that of silicon, which has a Mohs hardness of 7.0.

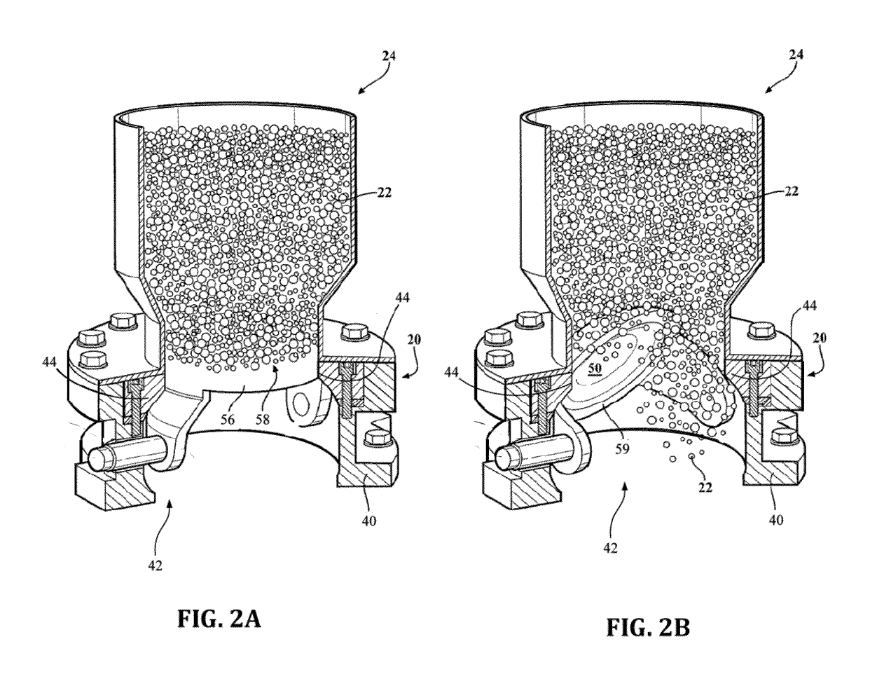

Characterization and testing of exemplary Si eutectic alloy specimens (see the Examples below) have shown that erosive wear resistance, fracture toughness, and other mechanical properties are linked to the microstructure of the eutectic alloy, particularly at the wear surface(s). The invention as claimed may modulate certain mechanical properties or microstructure of the eutectic alloy by adjusting one or more process conditions within effective limitations, e.g., by increasing or decreasing superheat temperature, or selecting a particular directional solidification method or process condition; by using a different M or combination of two or more M; or any combination thereof. Before discussing these experiments, an exemplary wear-resistant valve is set forth in reference to FIGS. 2A and 2B, and eutectic reactions and Si-rich eutectic alloys are described.

One of the advantages of fabricating a component including one or more wear surfaces comprising a Si eutectic alloy may be understood in reference to FIGS. 2A and 2B, which show a dome valve 20 connected to a fluidized bed reactor 24 used for producing a particulate silicon product 22, such as silicon beads, particles, fibers, or flakes. The dome valve 20 allows for selective dispensation of the silicon product 22 synthesized in the reactor. In some cases, the silicon product 22 may comprise high purity silicon, which means it has an impurity content of less than or equal to 1,000 parts per billion atomic (ppba).

Referring to FIGS. 2A and 2B, a sealing component (domed body) 50 comprising an obstructing surface 58 and a sealing surface 56 at a periphery of the obstructing surface 58 is rotatably disposed within the passageway 42 of the valve body 40 between a closed position (FIG. 2A) and an open position (FIG. 2B). In the closed position, the sealing surface 56 of the sealing component 50 engages the valve seat 44 and the obstructing surface 48 completely obstructs the opening 34 defined by the valve seat 44. Accordingly, the silicon product 22 from the fluidized bed reactor 24 cannot pass through the opening 34, as shown in FIG. 2A. In contrast, when the sealing component 50 is moved to the open position, as shown in FIG. 2B, the sealing surface 56 is disengaged from the valve seat 44 and the opening 34 is at least partially unobstructed, thereby allowing the silicon product 22 to pass through the opening. The sealing component 50 may be rotated into any of a continuum of open positions from the closed position (FIG. 2A) to the open position (FIG. 2B), including a plurality of predetermined open positions, where each open position results in a different size of the opening 34 defined by the valve seat 44. By controlling the size of the opening 34 defined by the valve seat 44, passage and rate of passage of the silicon product 22 from the fluidized bed reactor 24 and through the valve 20 may be controlled.

As can be seen in FIG. 2B, a significant amount of sliding (frictional) contact between the silicon product 22 and various components of the valve 20 is possible as the silicon product 22 passes through the opening and across exposed surfaces of such components. For silicon products in general and for high purity silicon products in particular, it may be important to minimize the transfer of contaminants from the valve 20 to the silicon product 22 during passage of the silicon product 22 therethrough. Consequently, one or more components of the dome valve 20 may include one or more wear-resistant (and thus non-contaminating) surfaces, such that frictional contact between the wear surface(s) and the silicon product 22 does not lead to contamination of the silicon. As noted previously, each of the sealing component 50, the valve seat 44 and the valve body 40 may include one or more non-contaminating wear surfaces. In one example, each of the sealing component 50 and the valve seat 44 comprises the one or more wear surfaces. In another example, each of the sealing component 50 and the valve body 40 comprises the one or more wear surfaces. In yet another example, each of the valve body 40 and the valve seat 44 comprises the one or more wear surfaces. It is also contemplated that each of the sealing component 50, the valve seat 44, and the valve body 40 comprises the one or more wear surfaces. In other embodiments, the sealing component 50, the valve seat 44, or the valve body 40 includes the one or more wear surfaces.

For example, the sealing component may include the one or more wear surfaces comprising the Si eutectic alloy. Referring again to FIG. 1, the wear-resistant sealing component 50 may be a dome valve component including a body 50 defining a dome shape with a top portion and an edge, where the top portion of the body 50 includes the obstructing surface 58 and the edge of the body includes the sealing surface 56. The wear surface of the sealing component 50 may include one or both of the obstructing surface 58 and the sealing surface 56. As illustrated in FIG. 2B, both the obstructing surface 58 and the sealing surface 56 may be subjected to sliding contact with the silicon product 22 during operation of the valve 20. In this example, the wear surface of the sealing component 50 is a curved surface having a semi-hemispherical shape. However, a sealing component 50 designed for other types of valves may include a wear surface having another shape. In addition, the underside 59 of the sealing component 50 may also be a wear surface.

The valve seat 44 may also or alternatively include such a wear surface. Because the opening defined by the valve seat encompasses a smaller cross-sectional area than the passageway, as can be seen in FIG. 1, the valve seat 44 may have repeated sliding contact with the silicon product 22 as it passes through the valve and across exposed surfaces of the valve seat. The valve body 40 also may be subjected to sliding contact with the silicon product 22 and may benefit from including a wear surface comprising the Si eutectic alloy.

Besides, or alternatively to, good wear properties, it is advantageous that the wear-resistant component exhibits good fracture toughness, alternatively good corrosion resistance, alternatively any combination thereof. Accordingly, the Si eutectic alloy may be present not just at the wear surface(s) but also within the bulk of the wear-resistant component. Consequently, the sealing component 50, the valve seat 44, and/or the valve body 40 of the exemplary dome valve 20 may have a fracture toughness of at least about 3.2 MPa·m^{1/2}. The fracture toughness may also be at least about 6 MPa·m^{1/2} and may not exceed 25 MPa·m^{1/2}. More particularly, the fracture toughness may be at least about 6 MPa·m^{1/2} measured in a direction along the wear surface(s) of the body, and the fracture toughness may be at least about 2.5 MPa·m^{1/2} measured in a direction perpendicular to the wear surface(s). The fracture toughness may be maintained, alternatively loss of fracture toughness may be inhibited, after exposure of the Si-rich eutectic alloy in the sealing component 50 to a corrosive environment such as a brine solution.

In addition to the exemplary dome valve 20 shown in FIG. 1, other types of valves, including ball valves, butterfly valves, gate valves, cylinder valves, plug valves and others, may include a wear-resistant component including a wear surface comprising a eutectic alloy, where the eutectic alloy comprises silicon, one or more metallic elements M, and a eutectic aggregation of a silicon-containing phase and a disilicide phase of formula MSi₂. It is also contemplated that the above-described wear-resistant component may be used in an application or a system other than a valve.

### Eutectic Reactions and Si Eutectic Alloys

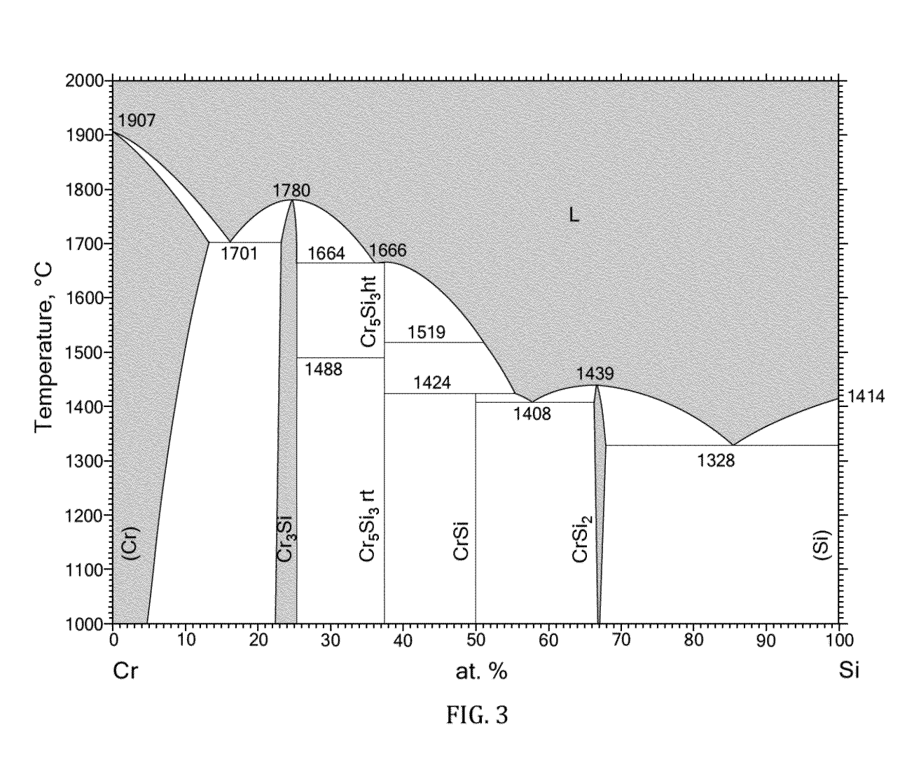

Referring to the exemplary phase diagram of FIG. 3, a eutectic reaction of the elements Si and M can be described as follows:

(1) L [symbol] Si+MSi₂, or
(2) L [symbol] MₓSi_{y}+MSi₂,

where a liquid phase (L) and two solid phases (e.g., Si and MSi₂ as in (1) or MₓSi_{y} and MSi₂ as in (2)) exist in equilibrium at a eutectic composition and the corresponding eutectic temperature. In the case of a binary eutectic alloy, the eutectic composition and eutectic temperature define an invariant point (or eutectic point). A liquid having the eutectic composition undergoes eutectic solidification upon cooling through the eutectic temperature to form a eutectic alloy composed of a eutectic aggregation of solid phases. Eutectic alloys at the eutectic composition melt at a lower temperature than do the elemental or compound constituents and any other compositions thereof (“eutectic” is derived from the Greek word “eutektos” which means “easily melted”).

In the case of a multicomponent eutectic alloy including two or more metallic elements M that each form a silicide, a eutectic boundary curve may be defined between multiple invariant points. For example, in the case of a ternary eutectic alloy including at least 50 at. % Si and two metallic elements (M=Mₐ,M_{b}) that undergoes reaction (1) above, the eutectic boundary curve joins two binary eutectic points, one defined by Si and MₐSi₂ and the other defined by Si and M_{b}Si₂. A liquid having a composition on the eutectic boundary curve undergoes eutectic solidification to form a eutectic alloy upon cooling.

The solid phases (e.g., Si and MSi₂ or MₓSi_{y} and MSi₂) that form upon cooling through the eutectic temperature at the eutectic composition define a eutectic aggregation having a morphology that depends on the solidification process. The eutectic aggregation may have a lamellar morphology including alternating layers of the solid phases, which may be referred to as matrix and reinforcement phases, depending on their respective volume fractions, where the reinforcement phase is present at a lower volume fraction than the matrix phase. In other words, the reinforcement phase is present at a volume fraction of less than 0.5. The reinforcement phase may comprise discrete eutectic structures, whereas the matrix phase may be substantially continuous. For example, the eutectic aggregation may include a reinforcement phase of rod-like, plate-like, acicular and/or globular structures dispersed in a substantially continuous matrix phase. Such eutectic structures may be referred to as “reinforcement phase structures.”

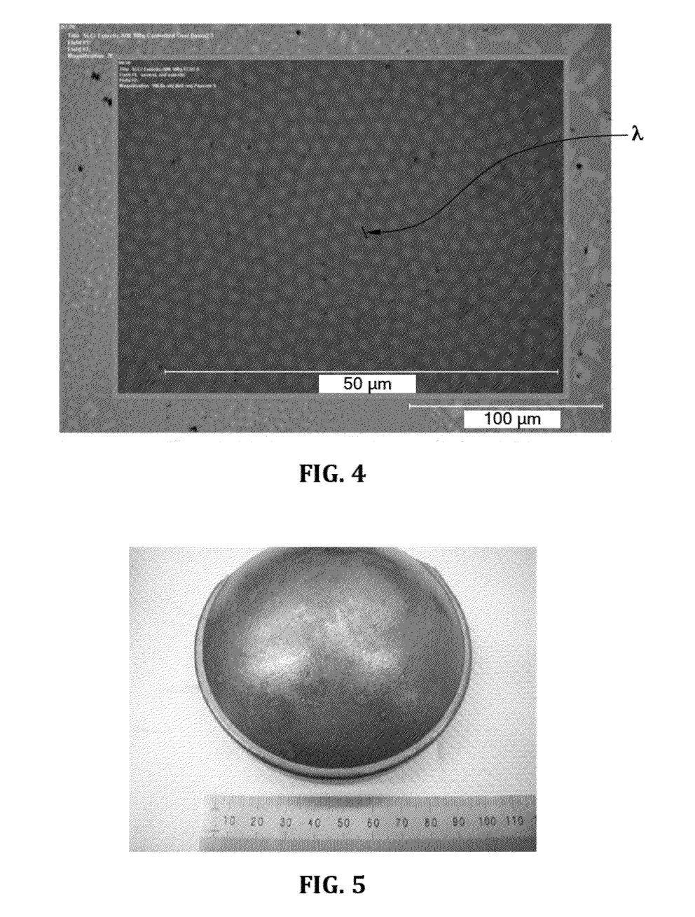

The reinforcement phase structures in the eutectic aggregation may further be referred to as high aspect ratio structures when at least one dimension (e.g., length) exceeds another dimension (e.g., width, thickness, diameter) by a factor of by a factor of 2 or more. Aspect ratios of reinforcement phase structures may be determined by optical or electron microscopy using standard measurement and image analysis software. The solidification process may be controlled to form and align high aspect ratio structures in the matrix phase. For example, when the eutectic alloy is produced by a directional solidification process, it is possible to align a plurality of the high aspect ratio structures along the direction of solidification, as shown for example in FIG. 4, which shows an optical microscope image of rod-like structures aligned perpendicular to the surface of an exemplary Si—CrSi₂ eutectic alloy sample (and viewed end-on in the image).

The reinforcement phase structures may be spaced apart from each other by an average characteristic spacing λ of 0.5 to 2 times the average lateral dimension of the structures. For example, for rod-like structures comprising an average diameter of from about 1 micron to about 50 microns, the average characteristic spacing 2 may be from about 500 nm to about 100 microns. In the case of smaller reinforcement phase structures (e.g., smaller diameter rods or smaller particles having an average lateral dimension in the range of from about 1 micron to about 5 microns), the average characteristic spacing λ may range from about 0.5 micron to about 10 microns, or from about 4 microns to about 6 microns. An average length of the reinforcement phase structures may range from about 10 microns to about 1000 microns, and more typically from about 100 microns to about 500 microns.

Generally, the terms “anomalous” or “irregular” and “normal” or “regular” may be used to describe the degree of uniformity of the eutectic aggregation, where at or near extremes of uniformity, anomalous or irregular eutectic structures are randomly oriented and/or nonuniform in size, and normal or regular eutectic structures exhibit a substantial degree of alignment and/or size uniformity. A “substantial degree” of alignment (or size uniformity) refers to a configuration in which at least about 50% of the eutectic structures are aligned and/or of the same size. Preferably, at least about 80% of the eutectic structures are aligned and/or of the same size. For example, a normal eutectic aggregation may include silicide rods of a given width or diameter embedded in a silicon phase in a configuration in which about 90% of the silicide rods are aligned. The silicide rods of the eutectic aggregation may be arranged in a single “colony” or in a plurality of colonies throughout the silicon matrix, where each colony includes rods of having a substantial degree of alignment. The phrases or terms “substantially aligned,” “substantially parallel,” and “oriented,” when used in reference to the reinforcement phase structures, may be taken to have the same meaning as “having a substantial degree of alignment.”

The eutectic alloys described here may be composed entirely or in part of the eutectic aggregation of silicon-containing and disilicide phases. When the eutectic alloy includes silicon and the metallic element(s) M at a eutectic concentration ratio thereof (i.e., at a eutectic composition of the alloy), then 100 volume percent (vol. %) of the eutectic alloy comprises the eutectic aggregation.

If, on the other hand, the eutectic alloy includes silicon and the metallic element(s) M at a hypoeutectic concentration ratio thereof, where the concentration of silicon is less than a eutectic concentration (with a lower limit of >0 at. % silicon), then less than 100 vol. % of the eutectic alloy comprises the eutectic aggregation. This is due to the formation of a non-eutectic phase prior to formation of the eutectic aggregation during cooling.

Similarly, if the eutectic alloy includes silicon and the metallic element(s) M at a hypereutectic concentration ratio thereof, where the concentration of silicon exceeds a eutectic concentration (with an upper limit of <100 at. % silicon), then less than 100 vol. % of the eutectic alloy may include the eutectic aggregation due to the formation of a non-eutectic phase prior to the eutectic aggregation during cooling.

Depending on the concentration ratio of the silicon and the metallic element(s) M, at least about 70 vol. %, at least about 80 vol. %, or at least about 90 vol. % of the eutectic alloy may comprise the eutectic aggregation.

The eutectic alloy described herein includes greater than 0 at. % Si, for example, at least about 50 at. % Si. The alloy may also include at least about 60 at. % Si, at least about 70 at. % Si, at least about 80 at. % Si, or at least about 90 at. % Si; and at most about 90 at. % Si, alternatively at most about 80 at. % Si, alternatively at most about 70 at. % Si, alternatively at most about 60 at. % Si; alternatively any usable combination of the foregoing at least and at most values, depending on the metallic element(s) M and whether a eutectic, hypoeutectic, or hypereutectic concentration ratio of the elements is employed. The eutectic alloy includes a total of 100 at. % of silicon, the one or more metallic elements M, and any residual impurity elements.

The silicon-containing phase may be an elemental silicon phase including crystalline silicon and/or amorphous silicon, as mentioned previously. Crystalline silicon may have a diamond cubic crystal structure, and the grain size or crystallite size may lie in the range of from about 200 nanometers (nm) to about 5 millimeters (mm) or more. Typically, the grain size is from about 1 μm to about 100 μm.

The metallic element(s) M may be one or more of chromium, cobalt, hafnium, molybdenum, nickel, niobium, rhenium, tantalum, titanium, tungsten, vanadium, and zirconium. When present, the intermetallic compound phase MₓSi_{y} may have a formula selected from MSi and M₅Si₃, such as CrSi, CoSi, TiSi, NiSi, V₅Si₃, Nb₅Si₃, Ta₅Si₃, Mo₅Si₃, and W₅Si₃. The disilicide phase MSi₂ may have a crystal structure selected from among the cubic C1, tetragonal C11_{b}, hexagonal C40, orthorhombic C49, and orthorhombic C54 structures. The crystal structure may be cubic C1. The crystal structure may be tetragonal C11_{b}. The crystal structure may be hexagonal C40. The crystal structure may be orthorhombic C49. The crystal structure may be orthorhombic C54. Each of cobalt disilicide (CoSi₂) and nickel disilicide (NiSi₂) has the cubic C1 crystal structure; each of molybdenum disilicide (MoSi₂), rhenium disilicide (ReSi₂), and tungsten disilicide (WSi₂) has the tetragonal C11b crystal structure; each of hafnium disilicide (HfSi₂) and zirconium disilicide (ZrSi₂) has the orthorhombic C49 crystal structure; and each of chromium disilicide (CrSi₂), niobium disilicide (NbSi₂), tantalum disilicide (TaSi₂), and vanadium disilicide (VSi₂) has the hexagonal C40 structure. Titanium disilicide (TiSi₂) has the orthorhombic C54 crystal structure.

Tables 1 and 2 below provide a listing of reactions for exemplary binary Si-rich eutectic systems, the corresponding invariant points, and information about the silicide phase that is formed in the reactions. Table 1 covers eutectic reactions that lead to an elemental silicon phase and a disilicide phase, and Table 2 covers the eutectic reactions that lead to a disilicide phase and an intermetallic compound phase other than a disilicide phase.

The theoretical volume fractions of MSi₂ were derived using the following approach, which is shown for the particular case of the Si—Cr system but may be generalized to any of the eutectic systems to arrive at the theoretical volume fractions set forth in Tables 1 and 2.

From the phase diagram, it is known that the Si—CrSi₂ eutectic point is at 85.5 at. % Si and 14.5% at. % Cr. The weight percent is calculated by the following:

$$\begin{matrix}\frac{0.855 * 28.086 g \text{/} mol}{( 0.855 * \frac{28.086 g}{mol} ) + ( 0.145 * \frac{51.996 g}{mol} )} = 0.76 * 100 = 76 wt . \% Si & ( 1 ) \\ \frac{0.145 * 51.996 g \text{/} mol}{( 0.855 * \frac{28.086 g}{mol} ) + ( 0.145 * \frac{51.9996 g}{mol} )} = 0.24 * 100 = 24 wt . \% Cr & ( 2 )\end{matrix}$$

Assuming a 100 g sample:

$$\begin{matrix}\frac{24 g}{51.9 g \text{/} mol} = 0.462 mol Cr & ( 3 ) \\ \frac{76 g}{28.086 g \text{/} mol} = 2.71 mol Si & ( 4 )\end{matrix}$$

During the reaction CrSi₂ is formed by consuming all of the Cr metal, thus there is 0.443 mol of CrSi₂. The molecular weight of CrSi₂ is 108.168 g/mol.

$$\begin{matrix}0.462 mol {CrSi}_{2} * 108.168 \frac{g}{mol} = 49.9 g {CrSi}_{2} & ( 5 ) \\ ( 2 , 71 mol - ( 2 * 0.462 mol ) ) * 28.086 \frac{g}{mol} = 50.1 g Si & ( 6 )\end{matrix}$$

The volume of each phase is calculated by dividing by the density of the materials:

$$\begin{matrix}\frac{49.9 g {CrSi}_{2}}{5.01 \frac{g}{{cm}^{3}}} = 9.96 {cm}^{3} & ( 7 ) \\ \frac{50.1 g Si}{2.33 \frac{g}{{cm}^{3}}} = 21.5 {cm}^{3} & ( 8 )\end{matrix}$$

The theoretical volume fraction of each phase is the volume of each phase divided by the total volume:

$$\begin{matrix}\frac{9.96 {cm}^{3}}{9.96 {cm}^{3} + 21.5 {cm}^{3}} = 0.316 = Volume Fraction {CrSi}_{2} & ( 9 ) \\ \frac{21.5 {cm}^{3}}{9.96 {cm}^{3} + 21.5 {cm}^{3}} = 0.683 = Volume Fraction Si & ( 10 )\end{matrix}$$

TABLE 1
Exemplary Eutectic Reactions L → Si + MSi₂.

| | Invariant or | | | |
|---|---|---|---|---|
| | Eutectic Point | | | |
| | Compo- | Temper- | MSi₂ | |
| | sition | ature | (vol. | MSi₂ |
| Eutectic Reaction | (wt. % Si) | (° C.) | fraction) | (wt. % Si) |
| L → Si + MoSi₂ | 93.5 | 1400 | 0.04 | 37 |
| L → Si + WSi₂ | 93.8 | 1390 | 0.02 | 23.4 |
| L → Si + VSi₂ | 94.7 | 1400 | 0.06 | 52.5 |
| L → Si + NbSi₂ | 93.7 | 1395 | 0.045 | 37.7 |
| L → Si + TaSi₂ | 80.6 | 1395 | 0.08 | 23.7 |
| L → Si + CrSi₂ | 76.0 | 1328 | 0.316 | 52.9 |
| L → Si + TiSi₂ | 75.5 | 1330 | 0.472 | 54 |
| L → Si + CoSi₂ | 62.1 | 1259 | 0.570 | 48.8 |

TABLE 2
Exemplary Eutectic Reactions L → MₓSi_{y} + MSi₂

| | Invariant or | | | |
|---|---|---|---|---|
| | Eutectic Point | | | |
| | Compo- | Temper- | MSi₂ | |
| | sition | ature | (vol. | MSi₂ |
| Eutectic Reaction | (wt. % Si) | (° C.) | fraction) | (wt. % Si) |
| L → Mo₅Si₃ + MoSi₂ | 25.6 | 1900 | 0.511 | 37 |
| L → W₅Si₃ + WSi₂ | 18.2 | 2010 | 0.716 | 23.4 |
| L → V₅Si₃ + VSi₂ | 44.2 | 1640 | 0.743 | 52.5 |
| L → Nb₅Si₃ + NbSi₂ | 28.6 | 1887 | 0.623 | 37.7 |
| L → Ta₅Si₃ + TaSi₂ | 19.8 | 1980 | 0.791 | 23.7 |
| L → CrSi + CrSi₂ | 41.7 | 1408 | 0.412 | 52.9 |
| L → TiSi + TiSi₂ | 51.0 | 1473 | 0.841 | 54 |
| L → CoSi + CoSi₂ | 43.5 | 1314 | 0.738 | 48.8 |
| L → NiSi + NiSi₂ | 38.04 | 949 | 0.390 | 48.9 |

In the case where the eutectic alloy is a multicomponent eutectic alloy including two or more elements M, it may be advantageous for each of the disilicides (MₐSi₂ and M_{b}Si₂) or intermetallic compounds (MSi or M₅Si₃) to have the same crystal structure and be mutually soluble so as to form in essence a single reinforcement phase (e.g., (Mₐ,M_{b})Si₂, (Mₐ,M_{b})Si, (Mₐ,M_{b})₅Si₃). For example, in the case of the disilicide phase, Mₐ and M_{b} may be Co and Ni, or Mo and Re. It is also envisioned that a multicomponent eutectic alloy may include two or more metallic elements M that form disilicides or intermetallic compounds with different crystal structures, such that the multicomponent eutectic alloy includes two or more insoluble silicide phases. For example, Mₐ and M_{b} may be Cr and Co, or Cr and Ni, which may form insoluble disilicide phases. Accordingly, exemplary ternary eutectic alloys may include two metallic elements M, where M=Mₐ, M_{b}, as set forth in Table 3:

TABLE 3
Exemplary Combinations of Metallic
Elements in Ternary Si Eutectic Alloys
M

| Mₐ | M_{b} |
|---|---|
| Co | Ni |
| Mo | Re |
| Mo | W |
| Re | W |
| Hf | Zr |
| Cr | Nb |
| Cr | Ta |
| Cr | V |
| Nb | Ta |
| Nb | V |
| Ta | V |
| Cr | Co |
| Cr | Ni |

### Microstructure and Properties of Eutectic Wear Surfaces

Investigations of the microstructure and mechanical properties of exemplary Si eutectic alloy specimens have shown that erosive wear resistance, fracture toughness, corrosion resistance, and/or other mechanical properties may be linked to the microstructure of the eutectic alloy at the wear surface of the body. In particular, the presence of one or more colonies of high aspect ratio silicide structures oriented substantially perpendicular to the specimen surface have been associated with improved mechanical properties such as low wear rates and high values of fracture toughness, corrosion resistance, or a combination thereof.

Accordingly, the eutectic aggregation may include one or more colonies of high aspect ratio structures (e.g., rod-like or plate-like structures) of the silicide phase oriented substantially perpendicular to the wear surface(s) of the body. For example, at least about 20 vol. % of the high aspect ratio structures may be oriented substantially perpendicular to the wear surface, and in some embodiments about 100 vol. % of the high aspect ratio structures may have the substantially perpendicular orientation. The high aspect ratio structures are advantageously disposed in the vicinity of the wear surface—that is, within a distance of about 5 microns from the wear surface.

Since the wear surface may be a curved surface, at least a portion of the high aspect ratio structures having the perpendicular orientation (with respect to the wear surface) may be oriented nonparallel to each other. For example, each of the oriented high aspect ratio structures may be oriented substantially perpendicular to a respective nearest position on the curved obstructing surface.

It is envisioned that 100 vol. % of the body may comprise the eutectic alloy. Alternatively, less than 100 volume percent of the body may comprise the eutectic alloy. For example, the body may include a surface portion or layer comprising the eutectic alloy (and including the wear surface) that overlies a support portion comprising a material other than the eutectic alloy. The surface layer may have a thickness ranging from about 100 nm to 2 mm. The material of the support portion may include a metal or alloy such as aluminum or steel.

### Fabrication of Wear-Resistant Component Comprising a Si Eutectic Alloy

A method of making a wear-resistant component is described here. The process allows for the controlled, directional solidification of a eutectic alloy melt to form a component comprising a Si eutectic alloy, where the alloy may exhibit a normal eutectic microstructure at a wear surface of the component.

The method comprises melting together silicon and one or more metallic elements M to form a eutectic alloy melt, and directionally removing heat from the eutectic alloy melt to directionally solidify the eutectic alloy melt. A wear-resistant component comprising a wear surface comprising the eutectic alloy is formed, where the eutectic alloy comprises silicon, one or more metallic elements M, and a eutectic aggregation of a first phase comprising silicon and a second phase of formula MSi₂, where the second phase is a disilicide phase.

The eutectic alloy melt may include silicon and the one or more metallic elements M at a eutectic concentration ratio thereof. Alternatively, the eutectic alloy melt may include silicon and the one or more metallic elements M at a hypoeutectic concentration ratio thereof, wherein the hypoeutectic concentration ratio has a lower limit based on a silicon concentration of >0 at. %. It is also contemplated that the eutectic alloy melt may include silicon and the one or more metallic elements M at a hypereutectic concentration ratio thereof, wherein the hyperutectic concentration ratio has an upper limit based on a silicon concentration of <100 at. % Si. The eutectic alloy formed from the eutectic alloy melt may have any of the attributes and chemistries described above.

Directionally removing heat from the eutectic alloy melt may entail moving a solidification front through the eutectic alloy melt, where the solidification front defines an interface between the eutectic alloy melt and the eutectic alloy composition. The heat may be directionally removed from the eutectic alloy melt in a mold having spaced apart inner and outer surfaces defining a wall therebetween, where the inner surface defines an enclosed volumetric space that contains the melt. A direction of travel of the solidification front may be away from the inner surface of the mold in a normal direction thereto. The eutectic aggregation of the eutectic alloy formed during solidification may include high aspect ratio structures of a reinforcement phase (which may be either the first phase or the second phase) oriented substantially parallel to the direction of travel of the solidification front, which may be the normal (perpendicular) direction with respect to the inner wall of the mold.

It is also contemplated that the direction of travel of the solidification front (and, consequently, the orientation of the high aspect ratio structures) may vary with distance away from the inner wall of the mold. For example, the mold may include one or more thermally conductive shunts arranged therein to control the direction the motion of the solidification front and the resulting alignment of the high aspect ratio structures.

To facilitate cooling, an outer surface of the mold, where the outer surface is separated from the inner surface by a wall of the mold, may be actively cooled by, for example, by water cooling, cooling with air or forced air or by modification of the mold surface to tune the thermal diffusivity to maintain control of thermal gradients. This could also include active cooling of the gas flow through the center of the casting to allow inside-out or outside-in solidification. In other words, it is also contemplated that the solidification front may travel from the center of the mold in an outward direction toward the inner wall of the mold.

As a consequence of either passive or active cooling, the outer surface of the mold may be cooled at a rate of at least about 10 degrees Celsius per minute (° C./min), at least about 50° C./min, at least about 100° C./min, or at least about 500° C./min. In addition, the heat may be removed from the eutectic alloy melt at a rate of at least about 10° C./min, at least 50° C./min, at least about 100° C./min, or at least about 500° C./min.

The mold may be made of a thermally conductive material such as graphite or a metallic or refractory material. Preferably, the material of the mold does not react with the eutectic alloy melt during processing. The mold may include a barrier coating on one or more surfaces that contact the eutectic alloy melt to inhibit or prevent a reaction between the melt and the mold material. The melting and solidification may take place in a vacuum or an inert gas environment. The vacuum environment is understood to be an environment maintained at a pressure of about 10⁻⁴ Torr (about 10⁻² Pa) or lower (where a lower pressure correlates to a higher vacuum). Preferably, the vacuum environment is maintained at a pressure of about 10⁻⁵ Torr (10⁻³ Pa) or lower and greater than 0 Pa.

The inner wall of the mold may be curved, and thus the resulting wear resistant component may have a curved surface. The mold and wear-resistant component together may comprise a multi-component article, wherein the mold and wear-resistant component may be in operative contact or connection. Alternatively, the method may further comprise separating the wear-resistant component and mold from each other to give the wear-resistant component without the mold. The wear-resistant component may be used directly in a process; alternatively, the wear-resistant component may be further processed, e.g., by machining. The wear-resistant component advantageously may be used in any industry, such as the oil and gas, semiconductor, and solar industries, having need of manufactured components with at least one robust mechanical property. For example, the component may be used to hold, block, and/or transfer an abusive material such as a hot crude oil or a mixture of hot crude oil and brine from an oil well or transfer of an abrasive material such as particulate silicon in a semiconductor or solar manufacturing operation.

The melting together may entail heating the silicon and the element(s) M to a predetermined temperature at or above the eutectic temperature and below a superheat temperature of the eutectic alloy, as defined below. The silicon and the element(s) M may alternatively be heated to a predetermined temperature at or above the superheat temperature of the Si eutectic alloy. It is advantageous that the molten silicon and the element(s) M are held at the predetermined temperature for a length of time sufficient for diffusion to occur and for the melt to homogenize.

The superheat temperature is preferably sufficiently far above the eutectic temperature to promote rapid diffusion and permit a homogeneous melt to be formed without an excessively long hold time (e.g., greater than about 60 min). Attaining a homogeneous melt prior to solidification is particularly important for alloys at the eutectic composition so that the entire volume of the melt undergoes eutectic solidification upon cooling. If local regions of the eutectic alloy melt include deviations from the eutectic composition, then these local regions may experience precipitation and coarsening of undesirable non-eutectic phases during solidification.

Accordingly, it is advantageous for the superheat temperature to be at least about 50° C. above the eutectic temperature, at least about 100° C. above the eutectic temperature, at least about 150° C. above the eutectic temperature, at least about 200° C. above the eutectic temperature, at least about 250° C. above the eutectic temperature, or at least about 300° C. above the eutectic temperature for the eutectic alloy. The superheat temperature may also be at most about 500° C. above the eutectic temperature, alternatively at most about 400° C. above the eutectic temperature, alternatively at most about 300° C. above the eutectic temperature, alternatively at most about 200° C. above the eutectic temperature; alternatively any usable combination of the foregoing at least and at most values. For example, for the Si—CrSi₂ system, the superheat temperature may lie in the range of from about 1400° C. to about 1600° C., which is from about 65° C. to about 265° C. above the eutectic temperature of the Si—Cr eutectic system.

Typically, the eutectic alloy melt is held at the predetermined temperature for a hold time of at most about 60 min, at most about 40 min, or at most about 20 min. The eutectic alloy melt may also be held at the predetermined temperature for at least about 5 min, for at least about 10 min, for at least about 20 min, for at least about 40 min, or for at least about 60 min; alternatively any usable combination of the foregoing at least and at most values. For example, the hold time may be from about 20 min to about 60 min. Lower hold times may be employed in conjunction with higher predetermined temperatures.

The wear-resistant component may be formed in a two-part casting process and may include a wear-resistant portion or layer disposed adjacent to another portion of the component, where the wear-resistant portion comprises a directionally solidified Si eutectic alloy and the other portion is cast or directionally solidified from another metal or alloy, such as an aluminum alloy or steel. The adjacent portions may be bonded or otherwise secured together. It is also contemplated that the portion or layer comprising the Si eutectic alloy may be formed by a thermal spray or other coating method.

### Corrosion Resistance

The wear-resistant Si eutectic alloys described herein may also exhibit exceptional corrosion-resistance. Chemical processes often involve aggressive environments, such hot hydrochloric acid (HCl) solutions. HCl is a reducing acid with highly acidic characteristics and reactive chloride ions that combine to make it a very corrosive chemical. Although many structural alloys exist today that are designed to resist corrosion, only a handful exhibit excellent resistance to aggressive, hot hydrochloric acid environments.

Toughened, castable Si eutectic alloys have been fabricated that exhibit excellent resistance to corrosion in HCl environments. In addition, the Si eutectic alloys may exhibit excellent corrosion resistance in sulfuric acid, formic acid, nitric acid, and hydrochloric+ferric chloride solutions of varying concentrations and temperatures. Such corrosion resistance may be particularly advantageous for industrial components, such as valve components.

An industrial component may include a body comprising a eutectic alloy including silicon, one or more metallic elements M, and a eutectic aggregation of a first phase comprising the silicon and a second phase of formula MSi₂, the second phase being a disilicide phase, where the body exhibits a corrosion rate of less than 1 mil per year (mpy) in a heated aqueous solution comprising an acid. The body may further exhibit a fracture toughness of at least about 3.2 megaPascals·meter^{1/2} (Mpa·m^{1/2}).

The aqueous solution may be at or above a boiling point thereof. The acid may be selected from the group consisting of sulfuric acid, phosphoric acid, formic acid, nitric acid, and hydrochloric acid. The acid may be present in the aqueous solution at a concentration of at least about 10 wt. % The concentration may also be at least about 20 wt. %, at least about 40 wt. %, or at least about 70 wt. %. In one example, the acid is hydrochloric acid and the concentration is at least about 20 wt. %.

The eutectic alloy may have any of the characteristics set forth previously. For example, the first phase may be an elemental silicon phase and wherein the one or more elements M may be selected from the group consisting of Cr, V, Nb, Ta, Mo, W, Co, Ti, Zr, and Hf. In one example of a eutectic alloy having high corrosion resistance, the one or more metallic elements M may include Cr, and the disilicide phase may be present at a concentration of from about 50 wt. % to about 60 wt. %. For example, the concentration of the disilicide phase may be about 54%.

Also as set forth above, the body of the industrial component may have a fracture toughness of at least about 2.5 MPa·m^{1/2} measured in a direction perpendicular to the wear surface of the body, and at least about 6 MPa·m^{1/2} measured in a direction along the wear surface of the body. The body may have a wear surface comprising a resistance to erosive wear sufficient to limit transfer of, when an abrasive product is passing thereacross, at least one of the one or more metallic elements M therefrom to the abrasive product, such that the abrasive product comprises an increase in contamination level of 200 parts per billion (ppb) or less of the at least one of the one or more metallic elements M after the passage. The body having the resistance to corrosion as set forth above may be a valve component for a dome valve, a ball valve, butterfly valve, gate valve, cylinder valve and/or plug valve.

### Example 1

### Fabrication of a Sealing Component for a Dome Valve

A 525 g charge containing 399 g of Si and 126 g of Cr was loaded into a graphite crucible (6.5″ outer diameter (OD), 4.5″ inner diameter (ID), 8″ height) which was then placed into an induction coil. The coil assembly and dome shaped mold (4″ diameter) were enclosed in a vacuum chamber (30″ diameter×50″ depth) and the chamber was evacuated to a pressure of 7×10⁻⁵ Torr. Power was applied to the induction coil at a frequency 3 kHz and a power of 30 kW. The temperature of the charge reached 1550° C. after ˜5-10 minutes of heating and the melt was allowed to homogenize for 5 minutes. The chamber was then backfilled with argon to 25″ Hg and the charge was reheated to the desired pour temperature (1550° C.). The melt was then poured into the graphite dome valve mold and allowed to solidify. The cooling rate and mold temperature were not controlled directly in this case; however, it may be preferred to control the thermal behavior of the mold and/or actively cool the mold to improve heat transfer. An image of the cast Si-alloy dome valve is shown in FIG. 5.

### Example 2

### Characterization—Optical Microscopy

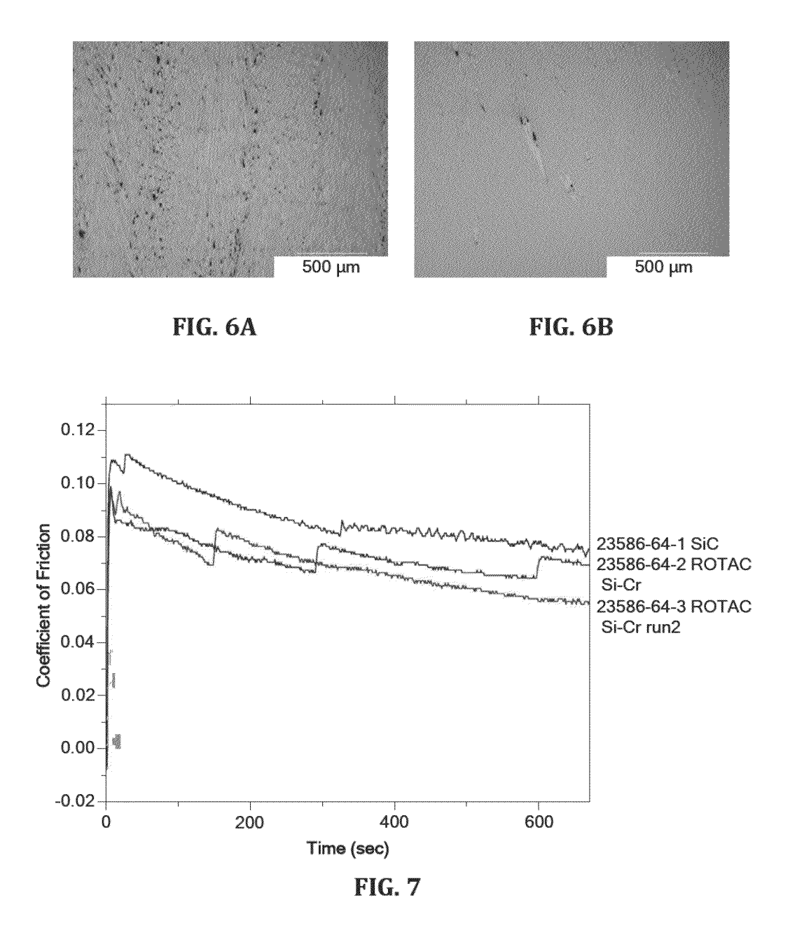

Exemplary sealing components for dome valves were sectioned using a diamond cut-off saw (Buehler Isomet 1000) and polished in both the perpendicular and parallel direction to heat flow. Optical micrographs of the resulting specimens are shown in FIG. 6A. The micrographs indicate that, as the melt solidified, the eutectic grew with the rods of CrSi₂ perpendicular to the dome valve surface. Once the solidification front reached the center of the part, the solidification was isotropic, as shown by the microstructure indicated in FIG. 6B. The directional growth of the CrSi₂ rods is attributed to the movement of the growth front away from the mold surface as heat is extracted through the graphite. Eutectic growth also occurs from the surface of the liquid, causing the isotropic solidification at the center of the component when the two solidification fronts meet. The heat flow may be further controlled by the incorporation of thermal shuts in the melt and active cooling of the graphite mold.

### Example 3

### Testing—Fracture Toughness

The fracture toughness in the parallel direction of the sealing component sections was measured using a chevron-notch 4-point bend test according to ASTM C1421. The procedure included cutting a chevron notch into each sample using a disco saw and then placing each notched sample into a 4-point bend tester. Load versus displacement was recorded for stable fracture and K_{IC}, the critical stress-intensity value or plane-strain fracture toughness, was calculated. The fracture toughness or K_{IC} value provides a measure of the resistance to crack extension in a brittle material.

The fracture toughness of the parallel orientation is 2.9 MPa·m^{1/2} with a standard deviation of 0.3 from a total of 6 valid measurements of 10 samples. The perpendicular direction to heat flow was not measured because a 40 mm long parallelepiped is required for testing and the samples were not thick enough. However, a toughness of 6-10 MPa·m^{1/2} is expected in the perpendicular orientation, as this value was obtained in samples of the same composition prepared with rods perpendicular to the crack propagation direction.

### Example 4

### Testing—Wear Rate

The data in FIG. 7 show the coefficient of friction between a Si abrasive ball and a fixed plate of Si—CrSi₂ during a standard measurement cycle carried out in accordance with ASTM G133 using a reciprocating wear tester. Data from an SiC reference material are shown for comparison. The discontinuities during the runs are a result of increasing the force to maintain a 25N load during testing. The Si—CrSi₂ sample tested in this example was prepared by rotational casting, which may be carried out as described in Example 8.

The coefficient of friction between the silicon ball and the Si—CrSi₂ eutectic alloy is comparable to that of the SiC reference material (Hexaloy SA, Saint Gobain Ceramics). The wear rate of Si eutectic alloys was expected to be higher than that of SiC; however, when normal eutectic structures with fine microstructure are present (due to proper tuning of processing and casting parameters), the wear rate can be comparable to SIC.

### Example 5

### Testing—Brine Treatment

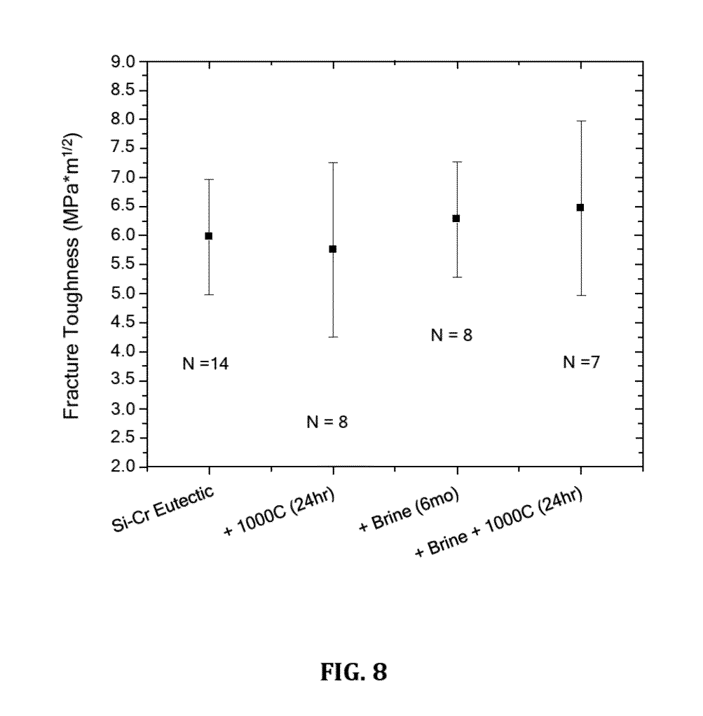

The data in FIG. 8 show fracture toughness of Si—CrSi₂ alloy samples prepared by rotational casting after elevated temperature exposure (1000° C. for 24 h) and after a 4-6 month treatment of the as-cast and thermally-treated Si—CrSi₂ materials in brine. As can be seen, there was no observable change in the fracture toughness of the samples after heat treatment or environmental exposure. The wear resistance of the samples also showed no observable change, and no measurable amount of Cr leached in the brine bath. The stability of the materials upon thermal/environmental exposure and the lack of leaching indicates they may be suitable for prolonged usage as valve components in a seawater environment, similar to those found in the oil and gas industry.

### Example 6

### Testing—Solid Abrasion Gravel Tests

In solid abrasion gravel tests carried out by Hemlock Semiconductor Corporation (Hemlock, Mich., USA) on the sealing component sections using 2-18 mm silicon chips in a standard test apparatus, the Si—CrSi₂ material performed comparably to cemented tungsten carbide and outperformed coatings on hardened metal. After testing, analysis of the Si chip surfaces indicated less than 1 ppb of the Cr transferred into the silicon, which is a promising indication of high erosive wear resistance and the utility of these materials in valve components and other high wear applications.

### Example 7

### Testing—Corrosion Resistance

Various Si rich eutectic alloys having the chemical compositions shown in Table 4 were screened for their resistance to general aqueous corrosion attack.

The corrosion studies were performed according to the protocol set forth in ASTM G31-72 (2004), “Standard Practice for Laboratory Immersion Corrosion Testing of Metals,” Test coupons comprising the Si-rich eutectic alloys were prepared as required in the standard (polished, cleaned, dried, weighed to the nearest 0.1 mg on an electronic laboratory balance and accurately measured for length, width, and thickness dimensions with a micrometer). Total immersion exposure was performed in a thick-walled Pyrex vessel fitted with a reflux condenser, an atmospheric seal, a thermowell and a temperature-regulating device. One to two test samples were immersed in an aqueous boiling acid solution (20 wt. % HCl) or caustic (30 wt. % KOH) media with two to four replications. The test solutions were maintained in static condition with minimal agitation (other than boiling induced bubbling and turbulence) or aeration unless noted otherwise.

TABLE 4
Si-rich Eutectic Alloy Compositions
Used in Corrosion Investigation

Eutectic
Composition, wt %

| Alloy | Si | CrSi₂ | CoSi₂ | VSi2 |
|---|---|---|---|---|
| Si—CrSi₂ | 46 | 54 | X | X |
| Si—CoSi₂ | 26 | X | 74 | X |
| Si—(Cr, Co)Si₂ | 5 | 59 | 36 | X |
| Si—(Cr, V)Si₂ | 83 | 14 | X | 3 |

TABLE 5
Average Weight Loss After Exposure to Boiling
Aqueous Solutions Containing HCl or KOH

| | Average Weight Loss | Average Weight Loss |
|---|---|---|
| DCC Si | in mg/cm² yr | in g/cm² day |
| Eutectics Alloys | 20% Boiling HCl* | 30% Boiling KOH** |
| Si—CrSi₂-Rotac | 0 | 12.50 |
| Si—CrSi₂-VIM | 0 | 5.70 |
| Si—CrSi₂-Vac | 0 | 2.70 |
| Si—CoSi₂ | 6599 | 0.01 |
| Si—(Cr,Co)Si₂ | 187549 | 0.20 |
| Si—(Cr,V)Si₂ | 7 | 5.80 |

*Test values determined from an average of 2-3 24-hour exposures;
**1 hour exposures

Each test coupon was then cleaned to remove corrosion products in methanol and deionized (DI) water. This was followed by thorough DI water rinse then drying in an oven at 120° C. for about 30 minutes. The test coupons were then weighed again to the nearest 0.1 mg. The weight loss was recorded and converted to a figure of average mass loss per surface area (by dividing the mass loss (in g or mg) by coupon surface area (in cm²) and time in years (1 day=0.002740 year). The results of these tests are summarized in Table 5.

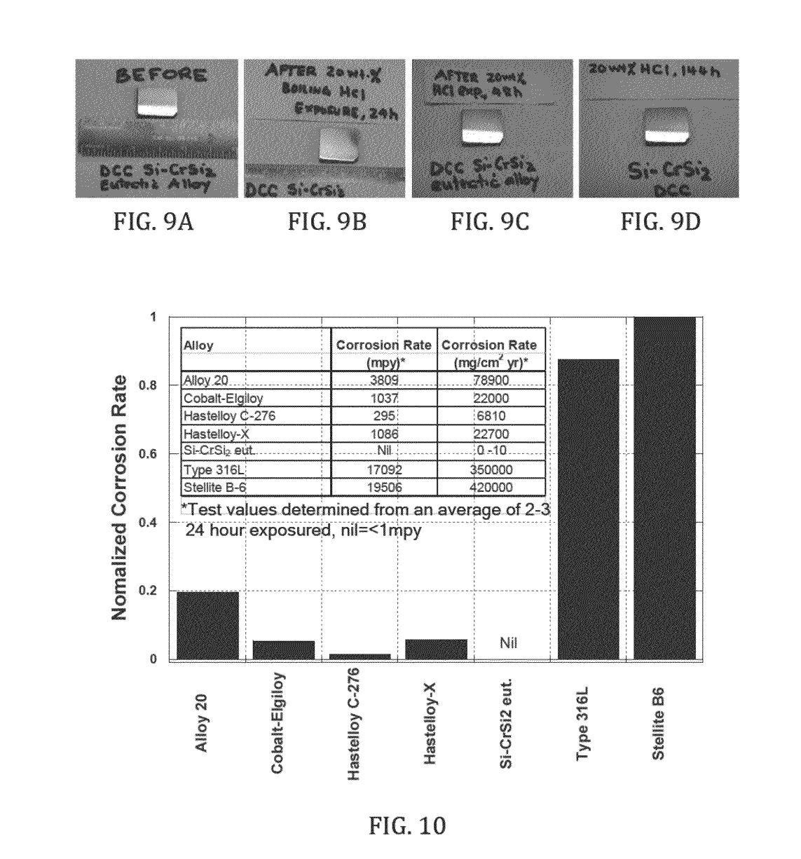

The weight loss of Si—CrSi₂ alloys in a boiling aqueous solution containing 20 wt. % HCl was determined to be negligible, as indicated in Table 5. The test coupons were immersed in the boiling 20 wt. % HCl solution for up to 144 h (the acid was refreshed every 48 h). No mass loss was detected and the Si—CrSi₂ eutectic alloys continued to maintain a polished luster even after 144 h of exposure, as shown in FIGS. 9A-9D.

Since Si—CrSi₂ alloys were found to resist corrosion in a boiling aqueous solution containing 20 wt. % HCl, comparative evaluations with various metallic alloys were undertaken. The test coupons were also tested for 24 h in a boiling 20 wt. % HCl solution. In addition to mass loss per surface area x time calculations, the weight loss was also converted to a figure of average depth of penetration in mil per year, mpy, in accordance with the relationship:

$${R}_{mpy} = \frac{3.45 \times {10}^{6} ( Wo - Wf )}{ATD} ,$$

where
R_{mpy}=corrosion rate in mil per year
Wₒ=original weight of sample coupon in grams
W_{f}=final weight of sample coupon in grams
A=area of sample in cm²
T=test duration in hours
D=density of composite or alloy in g/cm³

The results of these tests are set forth in Table 6 and FIG. 10, and

additional supporting information is set forth in Table 8.

TABLE 6
Comparative Corrosion Test Results

| | Corrosion | Corrosion |
|---|---|---|
| | Rate | Rate |
| Alloy | (mpy)* | (mg/cm² yr)* |
| Alloy 20 | 3809 | 78900 |
| Cobalt-Elgiloy | 1037 | 22000 |
| Hastelloy C-276 | 295 | 6810 |
| Hastelloy-X | 086 | 22700 |
| Si—CrSi₂ eut. | Nil | 0-10 |
| Type 316L | 17092 | 350000 |
| Stellite B-6 | 19506 | 420000 |

*Test values determined from an average of 2-3 24 hour exposures, nil = <1 mpy

FIG. 10 shows general corrosion rates of various engineering alloys and Si—CrSi₂ eutectic alloys in a boiling aqueous solution of containing 20 wt. % HCl. The inset shows corrosion rates of various engineering alloys and a Si—CrSi₂ eutectic alloy in the boiling 20 wt % HCl solution in mils/yr and mg/cm² yr.

The test Si—Cr test coupons were also tested for 14.5 days at 70° C. in a 25 wt % HCl boiling aqueous solution and compared with a silicon carbide technical ceramic (Hexoloy SA SiC) under the same conditions. The results are reported in Table 7.

TABLE 7
Comparative Aqueous Corrosion Data of Si—CrSi₂ Eutectic
Alloy versus Hexoloy ® SiC

Corrosive Weight Loss
mg/cm² yr*

| | | SiC ®- | Si—CrSi₂ |
|---|---|---|---|
| Test Environment | Temp. (° C.) | Hexoloy | Eutectic |
| 25 wt % HCl, | 70 | 1.03 ± 0.04 | 0.95 ± 0.03 |
| unaerated | | | |

*Test values determined from 4 test coupons. Test time: 14.5 days of submersive testing, intermittently stirred.

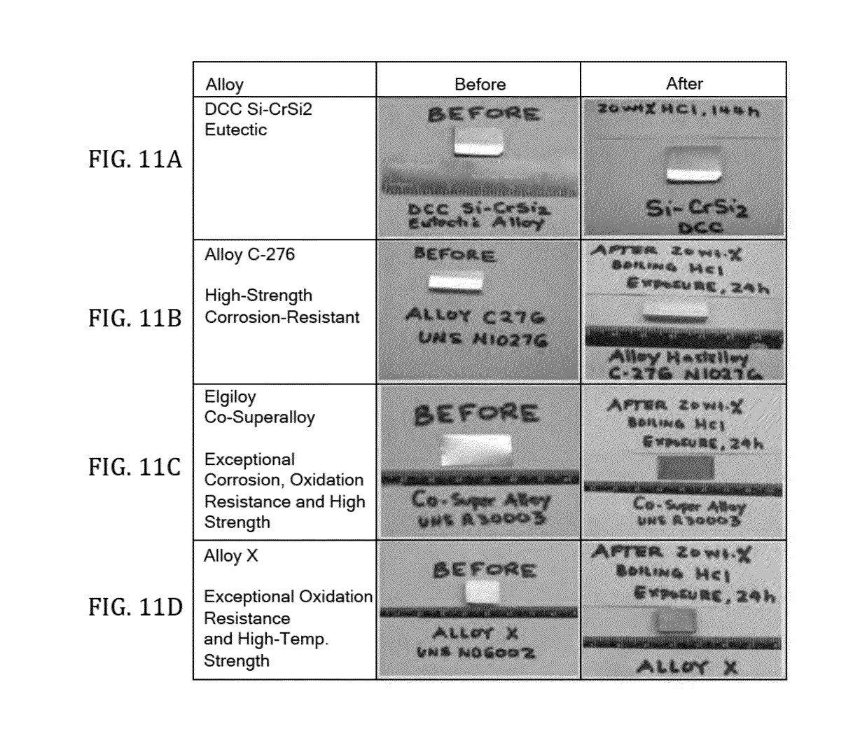

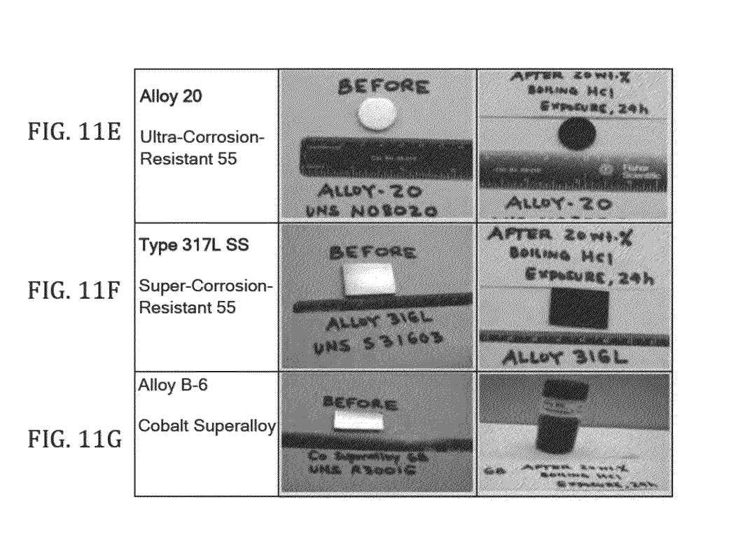

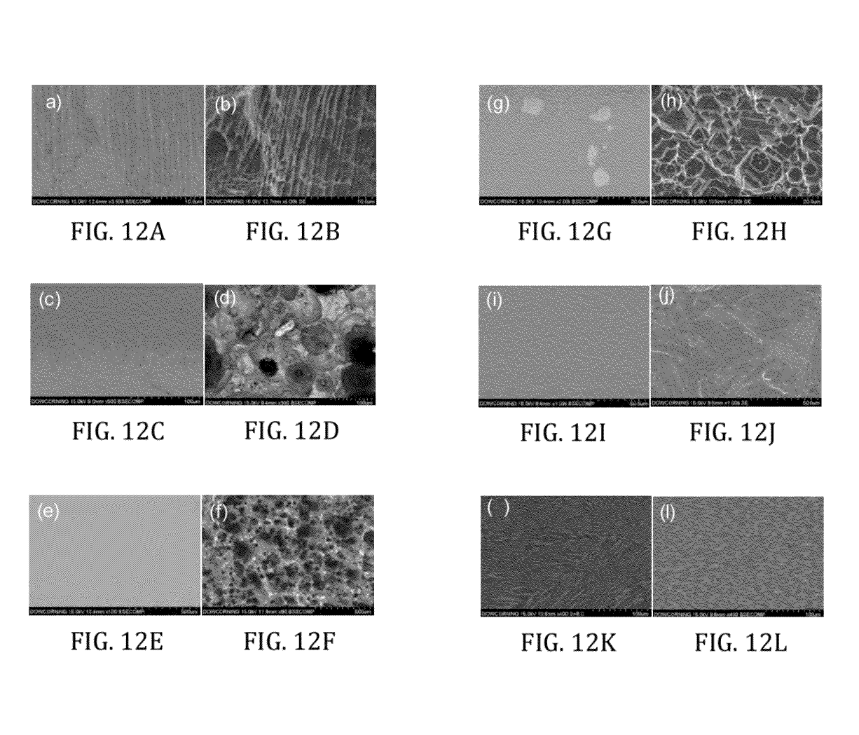

Sample coupons of a Si—Cr eutectic alloy were further tested under conditions similar to those described above in various aqueous acidic solutions up to boiling. The test coupons were cleaned, weighed and weight losses were calculated in mpy. The various acid test solutions and results of these tests with comparisons to Hastelloy C-276 and 316L SS are shown in Table 8. FIGS. 11 and 12 show additional supporting data. Specifically, FIGS. 11A-11G are images of alloy test coupons before and after immersion in a boiling aqueous solution containing 20 wt. % HCl. FIGS. 12A-12L are scanning electron micrographs of test coupons before (A, C, E, G, I, K) and after (B, D, F, H, J, L) immersion in a boiling aqueous solution containing 20 wt. % HCl for 24 hours, where the “before” surfaces are polished surfaces and the alloys shown are a cobalt superalloy (Elgiloy), Alloy 20, Type 316L, Alloy X, Alloy C-276, and a Si—CrSi₂ eutectic alloy, respectively.

TABLE 8
Corrosion Rate Comparison

| | | | Average Uniform | | |
|---|---|---|---|---|---|
| | | | Corrosion Rate, mpy | | |
| | | | DCC | | |
| | Conc., | Temp., | Si—CrSi2 | C-276 | Type |
| Corrodent | wt % | ° C. | eut. alloy | alloy | 316L |
| Sulfuric Acid | 10 | Boiling | Nil | 34 | 635 |
| | 65 | Boiling | Nil | 263 | 3835 |
| | >95 | 200 | Nil | 287 | 429 |
| | >95 | Boiling* | Nil | 301 | nd |
| Phosphoric Acid | 10 | Boiling | <2 | <1 | <1 |
| | 85 | Boiling | 56 | 41 | 634 |
| Formic Acid | >88 | Boiling | Nil | 1 | 16 |
| Nitric Acid | 10 | Boiling | Nil | 15 | <1 |
| | 70 | Boiling | Nil | 799 | 16 |
| Hydrochloric Acid | 20 | Boiling | Nil | 295 | >18000 |
| | 20 | 95 | Nil | 138 | nd |
| | 37 | Boiling | Nil | 8 | >15000 |
| Hydrofluoric Acid\hat{ } | 10 | 24 | 995 | 4 | nd |
| Hydrochloric Acid + | 20 | Boiling | <2 | nd | nd |
| Ferric Chloride | 2.5 | | | | |

Test values determined from an average of 2-3 24-hour exposures;
*6 hour exposure,
nd = not determined, nil < 1 mpy,
\hat{ }air-free (glove box)

The above-described tests cover a broad spectrum of acid corrosion environments and demonstrate that Si—Cr eutectic alloys have good resistance to aqueous solutions of hydrochloric and other acids.

### Example 8

### Fabrication—Rotational Casting of Test Samples

Since rotational casting was employed to provide test specimens for several examples described above, an exemplary rotational casting run is described here. A 90 kg batch, including 21.8 kg of chromium and the balance silicon, was melted in a 1000 lb induction furnace (Box InductoTherm) lined with a ceramic crucible (Engineered Ceramics Hycor model CP-2457) and sealed with a refractory top cap (Vesuvius Cercast 3000). During the melting process, the furnace was purged with argon by a liquid drip to reduce the formation of SiO gas and silicon dioxide.

The silicon eutectic melt was heated to 1524° C. prior to being poured into a refractory lined transfer ladle (Cercast 3000). The transfer ladle was preheated to 1600° C. using a propane/air fuel torch assembly. The temperature of the silicon eutectic melt in the transfer ladle was measured at 1520° C. prior to pouring into the rotational casting apparatus. Molten material from both the furnace and the transfer ladle was employed for elemental analysis to establish a baseline material composition.

A rotational casting apparatus (Centrifugal Casting Machine Co., model M-24-22-12-WC) was fitted with a refractory lined steel casting mold having nominal dimensions of 420 mm in diameter×635 mm in length. The eutectic alloy casting produced in this experiment measured 372 mm in diameter×635 mm in length×74 mm in wall thickness.

Prior to rotationally casting the eutectic alloy melt, Advantage W5010 mold wash was sprayed onto the inner surface of the rotating mold to provide a base coating of approximately 1 mm in thickness. The steel mold was rotated at 58 rpm and was preheated to 175° C. using an external burner assembly. The mold was then sped up to 735 rpm and hand-loaded with a sufficient volume of Cercast 3000 refractory to centrifugally create a 19 mm-thick first refractory layer within the mold. The mold was then transferred into a heat treatment oven whereby the mold was maintained at 175° C. for an additional 4 hours before being allowed to slowly cool to ambient temperature.

Next, Vesuvius Surebond SDM 35 was hand loaded into the mold cavity and the mold was spun at 735 rpm to uniformly generate a 6 mm-thick second refractory layer on the first refractory layer. After 30 min of spinning, the mold assembly was stopped and allowed to air dry for 12 hours.

A propane/oxygen torch was used to preheat the mold inner refractory surface to 1315° C. The torch nozzle was positioned flush to the 100 mm opening in the end-cap and was directed into the mold and allowed to vent out the rear 100 mm opening in the opposing end-cap.

A transfer ladle, supported on a Challenger 2 model 3360 weigh scale device, was used transfer the eutectic alloy melt from the induction furnace to the rotational casting mold. The eutectic alloy melt was poured from the transfer ladle at 1520° C. into the refractory-coated mold as it rotated at a speed of 735 rpm.

Mold speed was maintained at 735 rpm for 4 minutes to allow for impurity and slag separation. The mold speed was then slowly reduced to a point in which the material visually appeared as pooling in the bottom of the spinning mold and droplets appeared to be slumping at the top of the mold (near raining point). Mold speed was measured as 140 rpm and was maintained for 30 minutes with only ambient air cooling. The mold speed was then increased to 735 rpm and was maintained for 63 minutes of directional solidification. An alumina ceramic rod was inserted through the 100 mm opening in the mold cap to verify that the core of the casting was still liquid. The experiment was concluded when the casting was visually deemed solid and the dip rod was unable to penetrate the inner surface of the casting.

Experimental temperature data were recorded for the mold outside temperature using a Fluke 65 infrared thermometer measurement instrument. Internal mold and ladle temperatures were measured using a model OS524 infrared thermometer (Omega Engineering, Inc., Stamford, Conn.). The rotational speed of the mold (in rpm) was measured using a photo/contact tachometer with built-in infrared thermometer (Extech Instruments, Nashua, N.H.). Eutectic alloy melt temperatures were measured using an immersion temperature sensor (Heraeus ElectroNite model).

After 100% solidification, the casting was allowed to spin for an additional 45 minutes to provide air-cooling to the mold prior to removal from the rotational casting apparatus. The mold and casting were then removed and allowed to cool slowly overnight.

A hydraulic press was used to extract the casting from the steel mold body. The refractory shell was separated and the casting was blasted with silica grit to remove remaining traces of the refractory.

Although the present invention has been described in considerable detail with reference to certain embodiments thereof, other embodiments are possible without departing from the present invention. The spirit and scope of the appended claims should not be limited, therefore, to the description of the preferred embodiments contained herein. All embodiments that come within the meaning of the claims, either literally or by equivalence, are intended to be embraced therein. Furthermore, the advantages described above are not necessarily the only advantages of the invention, and it is not necessarily expected that all of the described advantages will be achieved with every embodiment of the invention.

1. An industrial component comprising:
a body comprising a wear surface, the body and the wear surface comprising a eutectic alloy including silicon, one or more metallic elements M, and a eutectic aggregation of a first phase comprising silicon and a second phase of formula MSi₂, the second phase being a disilicide phase,
wherein the wear surface comprises a resistance to erosive wear that is sufficient to limit transfer of, when an abrasive product is passing thereacross, at least one of the one or more metallic elements M therefrom to the abrasive product, the abrasive product comprising an increase in contamination level of 200 parts per billion (ppb) or less of the at least one of the one or more metallic elements M after the passage, or
wherein the body comprises a corrosion rate of less than 1 mil per year (mpy) in a heated aqueous solution comprising an acid.

2. The industrial component of claim 1, wherein the first phase is an elemental silicon phase and wherein the one or more elements M are selected from the group consisting of Cr, V, Nb Ta, Mo, W, Co, Ni, and Ti.

3. The industrial component of claim 1, wherein the first phase is an intermetallic compound phase selected from MSi and M₅Si₃ and wherein the one or more elements M are selected from the group consisting of Cr, V, Nb Ta, Mo, W, Co, Ni, and Ti.

4. The component of claim 1, wherein the eutectic aggregation comprises high aspect ratio structures of one of the first and second phases, and wherein at least a portion of the high aspect ratio structures are oriented substantially perpendicular to the wear surface of the body.

5. The component of claim 1, wherein the eutectic aggregation comprises high aspect ratio structures of one of the first and second phases, and wherein at least a portion of the high aspect ratio structures are oriented substantially perpendicular to the wear surface of the body.

6. The component of claim 1, wherein the heated aqueous solution is at or above a boiling point thereof, and wherein the acid is selected from the group consisting of sulfuric acid, phosphoric acid, formic acid, nitric acid, and hydrochloric acid.

7. A wear-resistant component for a valve, the component comprising:
a body comprising an obstructing surface for blocking passage of a material and a sealing surface at a periphery of the obstructing surface, at least one of the obstructing surface and the sealing surface being a wear surface comprising a eutectic alloy including silicon, one or more metallic elements M, and a eutectic aggregation of a first phase comprising silicon and a second phase of formula MSi₂, the second phase being a disilicide phase,
wherein the wear surface comprises a resistance to erosive wear sufficient to limit transfer of, when an abrasive product is passing thereacross, at least one of the one or more metallic elements M therefrom to the abrasive product, the abrasive product comprising an increase in contamination level of 200 parts per billion (ppb) or less of the at least one of the one or more metallic elements M after the passage.

8. The component of claim 7, wherein the first phase is an elemental silicon phase and wherein the one or more elements M are selected from the group consisting of Cr, V, Nb Ta, Mo, W, Co, Ni, and Ti.

9. The component of claim 7, wherein the first phase is an intermetallic compound phase selected from MSi and M₅Si₃ and wherein the one or more elements M are selected from the group consisting of Cr, V, Nb Ta, Mo, W, Co, Ni, and Ti.

10. The component of claim 7, wherein the eutectic aggregation comprises high aspect ratio structures of one of the first and second phases, and wherein at least a portion of the high aspect ratio structures are oriented substantially perpendicular to the wear surface of the body.

11. The component of claim 7, wherein the wear surface is a curved surface and each of the oriented high aspect ratio structures is oriented substantially perpendicular to a respective nearest position on the curved wear surface.

12. The component of claim 7, wherein the body comprises a dome having a top portion and an edge, the top portion of the dome comprising the obstructing surface and the edge of the dome comprising the sealing surface, the sealing component being a dome valve component.

13. The component of claim 7, wherein the body exhibits a corrosion rate of less than 1 mil per year (mpy) in a heated aqueous solution comprising an acid at a concentration of at least about 10 wt. %.

14. The component of claim 7, wherein the heated aqueous solution is at or above a boiling point thereof, and wherein the acid is selected from the group consisting of sulfuric acid, phosphoric acid, formic acid, nitric acid, and hydrochloric acid.

15. The component of claim 7, the body comprising a fracture toughness of at least about 2.5 MPa·m^{1/2} measured in a direction perpendicular to the wear surface of the body.

16. The component of claim 7, the body comprising a fracture toughness of at least about 6 MPa·m^{1/2} measured in a direction along the wear surface of the body.

17. A wear-resistant valve comprising:
a valve body comprising an inlet and an outlet and defining a passageway therebetween for passage of a material from the inlet to the outlet;
a valve seat coupled to or integrally formed with the valve body between the inlet and the outlet, the valve seat defining an opening in the passageway for passage of the material therethrough; and
a sealing component comprising a body having an obstructing surface for blocking the passage of the material and a sealing surface at a periphery of the obstructing surface, the sealing component being disposed within the passageway and configured for motion between a closed position and an open position,
wherein, when the sealing component is in the closed position, the sealing surface is engaged with the valve seat and the obstructing surface completely obstructs the opening,
wherein, when the sealing component is in the open position, the sealing surface is disengaged from the valve seat such that the opening allows the passage of the material therethrough; and
wherein at least one of the sealing component, the valve body and the valve seat comprises a wear surface comprising a eutectic alloy including silicon, one or more metallic elements M, and a eutectic aggregation of a first phase comprising silicon and a second phase of formula MSi₂, the second phase being a disilicide phase.

18. The wear-resistant valve of claim 17 selected from the group consisting of a dome valve, ball valve, butterfly valve, gate valve, cylinder valve and plug valve.

19. The wear-resistant valve of claim 17, wherein the wear surface comprises a resistance to erosive wear sufficient to limit transfer of, when an abrasive product is passing thereacross, at least one of the one or more metallic elements M therefrom to the abrasive product, the abrasive product comprising an increase in contamination level of 200 parts per billion (ppb) or less of the at least one of the one or more metallic elements M after the passage.

20. The wear-resistant valve of claim 17, wherein the first phase is an elemental silicon phase and wherein the one or more elements M are selected from the group consisting of Cr, V, Nb Ta, Mo, W, Co, Ni, and Ti.
